(19) United States
(12) Patent Application Publication
(10) Pub. No.: US 2008/0268179 A1
(43) Pub. Date: Oct. 30, 2008

(54) Method for producing laminate comprising liquid-crystalline polyester layer

(75) Inventors: Yujiro Kawaguchi, Ibaraki (JP); Yusaku Kohinata, Ibaraki (JP)

Correspondence Address: FOLEY AND LARDNER LLP;SUITE 500, 3000 K STREET NW, WASHINGTON, DC, 20007, US

(73) Assignee: Sumitomo Chemical Company Limited

(21) Appl. No.: 11/812,324

(22) Filed: Jun. 18, 2007

(30) Foreign Application Priority Data
Jun. 30, 2006 (JP) 2006-181144

(51) Int. Cl. C09K 19/00; B65H 81/00

(52) U.S. Cl. 428/1.1; 156/184

(57) ABSTRACT

A method for producing a laminate comprising a liquid-crystalline polyester resin layer and a metal foil was provided. The laminate has a reduced curling, and can be obtained by preparing a resin layer containing a liquid-crystalline polyester on one side of a metal foil, winding the resin layer with the metal foil into a roll so that the resin layer is outward and subjecting the roll to a heat treatment.

### BACKGROUND OF THE INVENTION

1. Field of the Invention

The present invention relates to a method for producing a laminate having a metal foil and a resin layer comprising a liquid-crystalline polyester. The present invention also relates to a laminate which is suitable for a flexible printed wiring board.

2. Description of the Related Art

A flexible printed wiring board (which may be, hereinafter, referred to as “FPC”) can be obtained by cladding is a metal foil and an electrical-insulation resin layer to obtain a laminate thereof and then preparing a circuit onto the metal foil in the laminate. While resin layers made of polyimide have been widely used as the electrical-insulation resin layer, a resin layer containing liquid-crystalline polyester is also advantageously utilized in FPC because of its low water-absorbing property, good electrical-insulation property and the like (for example, disclosed in JP-A-2005-342980).

Recently, with increasing requirements for light-weight, high-density and small-size electric and electronic parts in the market, the application of FPC is being enlarged. In such application, it has been demanded to obtain a laminate, which may comprise a metal foil and a resin layer containing liquid-crystalline polyester, with less curling, crimpling, shrinking or the like.

### SUMMARY OF THE INVENTION

One of the objects of the present invention is to provide a method for producing a laminate with reduced curling, crimpling, shrinking or the like, the laminate comprising a resin layer containing a liquid-crystalline polyester and being useful in application for FPC. The present inventors have zealously investigated and consequently have found a method of producing such a laminate with less curling, crimpling, shrinking or the like.

The present invention provides a method for producing a laminate comprising a liquid-crystalline polyester resin layer and a metal foil, the method comprising the steps of:

preparing a resin layer containing a liquid-crystalline polyester on one side of a metal foil;

winding the resin layer with the metal foil into a roll so that the resin layer is outward; and

subjecting the roll to a heat treatment.

Also, the present invention provides a laminate suitable for a flexible printed wiring board, which is obtainable by the above-described method.

In accordance with the present invention, a method for producing a laminate comprising a liquid-crystalline polyester resin layer is provided. The method is excellent in industrial production. Since the laminate obtainable by such a production method has significantly reduced curling, crimpling, shrinking or the like, fine patterning can be easily effected, and therefore, the laminate can be preferably used for a flexible printed wiring board for small-size electronic devices, even when the board needs to be miniaturized and have high density.

### BRIEF DESCRIPTION OF THE DRAWINGS

FIG. 1 is a partial cross sectional diagram of a laminate comprising a liquid-crystalline polyester resin layer when wound into a roll;

FIG. 2 is a cross sectional diagram schematically illustrating the process for winding up a laminate comprising a liquid-crystalline polyester resin layer together with a spacer;

FIG. 3 is a schematic top diagram showing a laminate comprising a liquid-crystalline polyester resin layer as viewed from the resin layer side when wound into a roll with spacers provided on both edges;

FIG. 4 is a schematic diagram showing a laminate with smaller curling when the curling properties of the laminate are evaluated; and

FIG. 5. is a schematic diagram showing a laminate with larger curling when the curling properties of the laminate are evaluated.

### DESCRIPTION OF THE PREFERRED EMBODIMENTS

A production method according to the present invention is an industrial method for producing a laminate comprising a liquid-crystalline polyester resin layer and a metal foil. In the production method, a resin layer containing a liquid-crystalline polyester is prepared on one side of a metal foil, the resin layer with the metal foil is wound into a roll so that the resin layer is outward; and the resulting roll is subjected to a heat treatment.

The thickness of the resin layer containing a liquid-crystalline polyester to be prepared on a metal foil is preferably in the range of from 1 μm to 500 μm from the viewpoint of layer-preparing processing and physical properties of the resin layer, and is more preferably in the range of from 1 μm to 200 μm from the viewpoint of handling. The thickness of the metal foil may be in the range of from 3 μm to 70 μm, and is preferably in the range of from 9 μm to 35 μm. Examples of the metal foil may include foils, thin films and sheet films of metal such as gold, silver, copper, aluminum and nickel. Among them, copper foils are preferably used from the viewpoint of conductivity and cost. In terms of the dimensions of the metal foil, the metal foil may have the width of from 150 mm to 1500 mm and the length of from 1 m to 6000 m. An optimal metal foil can be selected depending on the form of FPC to which the resulting laminate of the liquid-crystalline polyester is applied.

Examples of the method for preparing the resin layer on the metal foil may include a laminating method and a solution casting method in which a solution composition comprising a liquid-crystalline polyester (such as an aromatic liquid-crystalline polyester) and a solvent is applied onto a metal foil. In particular, the solution casting method is preferable since the operation thereof is easily conducted. One of the liquid-crystalline polyesters suitable for the solution casting method is an aromatic liquid-crystalline polyester which is soluble in a solvent. Examples of the aromatic liquid-crystalline polyester include aromatic liquid-crystalline polyester soluble in a halogenated phenol, an aprotic solvent and the like, as disclosed in JP-A-2004-269874 and JP-A-2005-342980 (both of which are incorporated herein by reference). Among these, the aromatic liquid-crystalline polyester soluble in an aprotic solvent is preferably used in the present invention.

In the present invention, a resin layer comprising a liquid-crystalline polyester is utilized. The liquid-crystalline polyester may be an aromatic liquid-crystalline polyester, which mainly contains structural units derived from, for example, aromatic hydroxycarboxylic acid, aromatic diol, aromatic diamine, aromatic amine with hydroxyl group(s) and aromatic dicarboxylic acid. In view of solubility and liquid crystallinity, it is preferred to use a liquid-crystalline polyester having structural units represented by formulas (i) to (iv) respectively below:

—O—Ar1-CO—, (i)

—X—Ar2-Y—, (ii)

—CO—Ar3-CO— and (iii)

—CO—Ar4-Z-Ar5-CO—, (iv)

wherein Ar1 represents at least one selected from a group consisting of 1,4-phenylene, 2,6-naphthylene and 4,4′-biphenylene; Ar2 represents at least one selected from a group consisting of 1,4-phenylene, 1,3-phenylene and 4,4′-biphenylene; X and Y independently represent —O— or —NH—; Ar3 represents at least one selected from a group consisting of 1,4-phenylene, 1,3-phenylene and 2,6-naphthylene; Ar4 and Ar5 independently represent at least one selected from a group consisting of 1,4-phenylene, 2,6-naphthylene and 4,4′-biphenylene; and Z represents at least one selected from a group consisting of —O—, —SO₂— and —CO—,
in which the amount of unit (1) is 30-80% by mol, the amount of unit (2) is 10-35% by mol and the total amount of units (3) and (4) is 10-35% by mol, the amounts of which are all on the molar basis of the total amount of monomers (1) to (4). Structural unit (1) can be derived from aromatic hydroxycarboxylic acid; structural unit (2) can be derived from aromatic diol, aromatic diamine and/or aromatic amine with hydroxyl group(s); and structural units (3) and (4) can be derived from aromatic dicarboxylic acid.

Since the structural units (1)-(4) can be derived from the above-mentioned compounds, the liquid-crystalline polyester can be produced by polymerizing such compounds in a known method. Instead of using such compounds, ester-forming and amide-forming derivatives corresponding to the compounds can also be utilized to produce the liquid-crystalline polyester.

Among the ester-forming derivatives, examples of the ester-forming derivatives of the compounds having carboxyl groups include highly reactive derivatives such as an acid chloride or an acid anhydride, which can facilitate the formation of polyester; and esters made of carboxylic acids and an alcohol or ethylene glycol, which can produce polyesters by trans-esterification.

Among the ester-forming derivatives, examples of the ester-forming derivatives of the compounds having phenoic hydroxyl groups include esters made of the carboxylic acids and the phenoic hydroxyl groups, which can produce polyesters by trans-esterification.

Among the amide-forming derivatives, examples of the amide-forming derivatives of the compounds having amino groups include amides made of the carboxylic acids and the amino groups, which can produce polyamides by amide-exchange reaction.

Examples of structural unit (1) include units derived from an aromatic hydroxycarboxylic acid such as p-hydroxybenzoic acid, 2-hydroxy-6-naphthoic acid and 4-hydroxy-4′-biphenyl-4-carboxylic acid. The unit derived from 2-hydroxy-6-naphthoic acid is preferred. Two or more kinds of unit (1) may be contained in the liquid-crystalline polyester.

In the liquid-crystalline polyester, structural unit (1) is preferably contained in the amount of 30-80% by mol on the molar basis of the total amount of structural units contained in the polyester. The amount of unit (1) is more preferably 35-65% by mol, and is most preferably 40-55% by mol. When the amount of unit (1) is in the range of 30-80% by mol, the resulting polyester tends to have high solubility in a solvent (which is advantageous when the polyester is used in a cast method) and also maintain good liquid crystallinity, desirably.

Examples of structural unit (2) include units derived from an aromatic diamine such as 1,3-phenylenediamine and 1,4-phenylenediamine; units derived from an aromatic amine having a phenolic hydroxyl group such as 3-aminophenol and 4-aminophenol; units derived from 4,4′-diaminodiphenylether, 4-hydroxy-4′-biphenylalcohol and the like. The unit derived from 4-aminophenol is preferred in view of reactivity. Two or more kinds of unit (2) may be contained in the liquid-crystalline polyester.

In the liquid-crystalline polyester, structural unit (2) is preferably contained in the amount of 10-35% by mol on the molar basis of the total amount of structural units contained in the polyester. The amount of unit (2) is more preferably 17.5-32.5% by mol, and is most preferably 22.5-30% by mol. When the amount is in the range of 10-35% by mol, the resulting polyester tends to have high solubility in a solvent (which is advantageous when the polyester is used in a cast method) and also maintain good liquid crystallinity, desirably.

Examples of structural unit (3) include units derived from an aromatic dicarboxylic acid such as terephthalic acid, isophthalic acid and 2,6-naphthalene dicarboxylic acid. The unit derived from isophthalic acid is preferred in view of solubility of the resulting polyester. Two or more kinds of unit (3) may be contained in the liquid-crystalline polyester.

Examples of structural unit (4) include units derived from an aromatic dicarboxylic acid such as diphenylether-4,4′-dicarboxylic acid, diphenylsulfone-4,4′-dicarboxylic acid and benzophenone-4,4′-dicarboxylic acid. The unit derived from diphenylether-4,4′-dicarboxylic acid is preferred in view of reactivity and cost. Two or more kinds of unit (4) may be contained in the liquid-crystalline polyester.

Structural units (3) and (4) are preferably contained in the liquid-crystalline polyester so that the total amount of units (3) and (4) is 10-35% by mol on the molar basis of the total amount of the units contained in the polyester. The total amount of units (3) and (4) is more preferably 17.5-32.5% by mol, and is most preferably 22.5-30% by mol.

Structural unit (4) is optionally contained in the liquid-crystalline polyester in the amount of 1% by mol or larger on the molar basis of the total amount of the units contained in the polyester. The amount of monomer (4) is preferably 1-35% by mol, is more preferably 10-30% by mol, and is most preferably 15-25% by mol.

The polymerization degree of the polyester can be controlled by adjusting the molar ratio of the amount of the monomer corresponding to unit (2) to the total amount of monomers corresponding to units (3) and (4). The molar ratio is calculated by dividing the amount of monomer corresponding to unit (2) by the total amount of monomers corresponding to units (3) and (4) (i.e., [the amount of the monomer for unit (2)]/[the total amount of monomers for units (3) and (4)]). The ratio is preferably in the range of from 0.85 to 1.25. More preferably, the monomer corresponding to unit (2) is used in the equivalent amount (by mole) of the total amount of monomers corresponding to units (3) and (4).

As mentioned above, the liquid-crystalline polyester in the present invention is a polyester which can be obtained by polymerizing monomers corresponding to units (1) to (4), such as an aromatic hydroxycarboxylic acid, an aromatic diol, an aromatic diamine, an aromatic amine with hydroxyl group(s), an aromatic dicarboxylic acid, and an ester-forming or amide-forming derivatives thereof. For example, the polymerization may be conducted in the methods disclosed in JP-A-2002-220444, JP-A-2002-146003 and the like.

For example, the liquid-crystalline polyester may be obtained by a method in which the phenolic hydroxyl groups and/or amino groups (of the aromatic hydroxycarboxylic acid for unit (1), the aromatic amine having a phenolic hydroxyl group and the aromatic diamine for unit (2)) are acylated with an excess amount of carboxylic anhydride to obtain acylated compounds (monomers) thereof, and the acylated compounds are subjected to melt-polymerization with the aromatic dicarboxylic acid for unit (3) and/or (4) to conduct transesterification and amide exchange (polycondensation).

In the acylation process, the amount of the carboxylic anhydride is preferably from 1.0 to 1.2 equivalents, more preferably from 1.05 to 1.1 equivalents, per one equivalent of the total amount of the phenolic hydroxyl group and amino group.

When the amount of the carboxylic anhydride is in the range of 1.0 to 1.2 equivalents, the acylated compound and the raw monomers tend to be difficult to sublime during the trans-esterification and/or amide exchange (polymerization) so that clogging in a reaction system can be effectively reduced, thereby suppressing the coloring of the resulting liquid-crystalline polyester.

The acylation is preferably carried out at a temperature of 130 to 180° C. for 5 minutes to 10 hours, more preferably at a temperature of 140 to 160° C. for 10 minutes to 3 hours.

The kind of the carboxylic anhydride used for acylation is not limited. Examples of the carboxylic anhydride include acetic anhydride, propionic anhydride, butyric anhydride, isobutyric anhydride, valeric anhydride, pivalic anhydride, 2-ethylhexanoic anhydride, monochloroacetic anhydride, dichloroacetic anhydride, trichloroacetic anhydride, monobromoacetic anhydride, dibromoacetic anhydride, tribromoacetic anhydride, monofluoroacetic anhydride, difluoroacetic anhydride, trifluoroacetic anhydride, glutaric anhydride, maleic anhydride, succinic anhydride, 1-bromopropionic anhydride, etc. These anhydrides may be used independently or in admixture of two or more of them.

Among them, acetic anhydride, propionic anhydride, butyric anhydride and isobutylic anhydride are preferable from the viewpoint of their costs and handling. More preferably, acetic anhydride is used.

In the trans-esterification and/or amide exchange (polymerization), the acylated compound is preferably used in such an amount that the equivalent of the acyl group is 0.8 to 1.2 times the equivalent of the carboxyl group.

The polymerization is preferably carried out in a temperature range between 130 and 400° C., and more preferably in a temperature range between 150 and 350° C. In raising a temperature for the polymerization, the rate of raising the temperature is preferably in the range of from 0.1 to 50° C./min., more preferably in the range of from 0.3 to 5° C./min.

The unreacted carboxylic anhydride and by-produced carboxylic acids are preferably removed from the reaction system by, for example, evaporation to shift the equilibrium in reaction to the product side during the polymerization.

The acylation and/or the polymerization may be carried out in the presence of a catalyst. The catalyst may be a conventional catalyst which has been used as a polymerization catalyst for polyester. Examples of the catalyst include metal salt catalysts (e.g. magnesium acetate, stannous acetate, tetrabutyl titanate, lead acetate, sodium acetate, potassium acetate, antimony trioxide, etc.), organic compound catalysts such as a heterocyclic compound having two or more of nitrogen atoms (e.g. N,N-dimethylaminopyridine, N-methylimidazole, etc.) and so on.

Among them, a heterocyclic compound such as N,N-dimethylaminopyridine and N-methylimidazole can be preferably used as the catalyst (see, JP-A-2002-146003).

The catalyst may be added to a reactor when the monomers are charged in the reactor for producing the polyester. The catalyst used in the acylation may not necessarily be removed, and the reaction mixture obtained by the acylation may be subjected to the polymerization.

The polymerization may be carried out by melt-polymerization, which may be followed by solid phase polymerization. When the solid phase polymerization is conducted, the polymer obtained from the melt-polymerization is preferably milled to provide a powder-form or flake-form polymer, which may be then subjected to the conventional solid phase polymerization. For example, in the solid-phase polymerization, the polymer obtained from the melt-polymerization is heated in an atmosphere of an inert gas such as nitrogen at a temperature of 150 to 350° C. for 1 to 30 hours.

The solid phase polymerization may be carried out with or without agitating the polymer. When a reactor is equipped with a suitable agitation mechanism, the melt-polymerization and the solid phase polymerization can be carried out in the same reactor. After the solid phase polymerization, the liquid-crystalline polyester obtained may be pelletized in a conventional manner and then molded or shaped.

The liquid-crystalline polyester may be produced batchwise or continuously.

By the above-described production method, an aromatic liquid-crystalline polyester soluble in an aprotic solvent can be obtained.

In the present invention, a resin layer comprising an aromatic liquid-crystalline polyester may be prepared on a metal foil using a solution composition comprising the aromatic liquid-crystalline polyester. The solution composition may be produced by mixing the aromatic liquid-crystalline polyester with an aprotic solvent.

In the solution composition, the aromatic liquid-crystalline polyester may be contained in the amount of is 0.01 to 100 parts by weight based on 100 parts by weight of the aprotic solvent. When the amount of the liquid-crystalline polyester is within the above-described range, the resulting solution composition has a preferable viscosity, which may result in uniformly applying the solution composition onto a substrate (such as a metal foil).

From the viewpoint of workability and cost, the liquid-crystalline polyester is contained preferably in the amount of 1 to 50 parts by weight, and more preferably in the amount of 2 to 40 parts by weight, based on 100 parts by weight of the aprotic solvent.

Examples of the aprotic solvent include a halogenated solvent such as 1-chlorobutane, chlorobenzene, 1,1-dichloroethane, 1,2-dichloroethane, chloroform and 1,1,2,2-tetrachloro ethane; an ether such as diethyl ether, tetrahydrofuran and 1,4-dioxane; a ketone such as acetone and cyclohexanone; an ester such as ethyl acetate; a lactone such as γ-butyrolactone; a carbonate such as ethylene carbonate and propylene carbonate; an amine such as triethylamine and pyridine; a nitrile such as acetonitrile, succinonitrile; an amide such as N,N-dimethylformamide, N,N-dimethylacetamide, tetramethylurea, 1-methyl-2-pyrrolidone; a nitro compound such as nitromethane and nitrobenzene; a sulfide such as dimethylsulfoxide and sulfolane; and a phosphoric acid such as hexamethylphosphoramide and tri-n-butyl phosphate.

Among these, the solvents which do not have halogen atom are preferred from the environmental point of view. From the viewpoint of solubility, the solvents preferably have a dipole moment of 3 to 5. Preferred solvents are an amide solvent such as N,N-dimethylformamide, N,N-dimethylacetamide, tetramethylurea, 1-methyl-2-pyrrolidone; and a lactone solvent such as γ-butyrolactone. More preferred solvents are N,N-dimethylformamide, N,N-dimethylacetamide and 1-methyl-2-pyrrolidone.

The solution composition which can be utilized in the present invention preferably contains the aprotic solvent, but can contain other solvents within the amount of not providing adverse effects in the production of the laminate in the present invention.

The solution composition can be subjected to filtration, if necessary, so that fine impurities contained in the solution composition are removed.

In view of controlling the properties of the resulting resin layer, the solution composition may contain filler, additive, thermoplastic resin and the like.

Examples of the filler include organic fillers such as epoxy resin powder, melamine resin powder, urea-formaldehyde resin powder, benzoguanamine resin powder and styrene resin powder; and inorganic fillers such as silica, alumina, titania, zirconia, kaolin, calcium carbonate, calcium dihydrogen phosphate, aluminum borate, potassium titanate, magnesium sulfate, zinc oxide, silicon carbide, silicon nitride, glass fiber and alumina fiber.

Examples of the additive include coupling agent, anti-settling agent, ultraviolet absorber, heat stabilizer and antioxidant.

Examples of the thermoplastic resins include polypropylene, polyamide, polyester, polyphenylene sulfide, polyether ketone, polycarbonate, polyether sulfone, polyphenyl ether and modification products thereof, polyether imides, and elastomer such as copolymers of etylene and glycidylmethacrylate.

Using the solution composition, a resin layer containing the liquid-crystalline polyester can be prepared in a simple method such as solution casting method. For example, a resin layer containing the liquid-crystalline polyester can be produced on a metal foil by applying the solution composition onto the metal foil and removing at least a portion of the solvent in the solution composition so that the resulting layer is tack-free.

Examples of the method of applying the solution composition include a roll coating method, a gravure coating method, a knife coating method, a blade coating method, a Mayer rod coating method, a dip coating method, a spray coating method, a curtain coating method, a slot die coating method, a screen printing method and the like.

Methods for removing the solvent are not particularly limited, and preferred method is evaporation of the solvent. The evaporation of the solvent may be carried out by heating, decompression, ventilation or the like. Among them, evaporation with heating is preferred from the viewpoint of productivity and workability, and evaporation with heating while ventilation is more preferred.

The removal of the solvent is preferably carried out so that the amount of solvent remaining in the resin layer is no more than 18% by weight on a basis of the resulting resin layer (obtained after the removal of the solvent). The temperature and time for the removal are not limited. The removal of the solvent may be conducted at a temperature of no higher than 160° C., preferably at a temperature of no higher than 150° C., and more preferably at a temperature of no higher than 140° C. In the case where the temperature is too high, defects may occur on the surface of the resin layer. On the other hand, in the case where the temperature is too low, the time required for the solvent removal becomes too long and the productivity tends to be reduced. Therefore, the removal of the solvent is preferably carried out at a temperature of no lower than 60° C. It is preferred that the solvent remains in the resulting resin layer in the amount of no more than 18% by weight. In such a case, the resin layer becomes tack-free, which results in reducing curling of the resulting laminate having the resin layer. The amount of solvent remaining in the resin layer is more preferably no more than 15% by weight. The removal of the solvent may be conducted by allowing the metal foil on which the solution composition is applied to pass through a heating oven, which is placed on the way to feed the resulting laminate to be a roll.

FIG. 1 is a partial cross sectional diagram of a laminate comprising a liquid-crystalline polyester resin layer when wound into a roll. Referring to FIG. 1, one of example methods of the present invention is described as follows:

A laminate 10 having a resin layer 3 and a metal foil 2 is wound onto a core 1 so that the side of resin layer 3 is placed outward. Such a winding of the laminate (in which the resin layer side of the laminate is placed outward compared to the metal foil side) is hereinafter referred to as “outside winding”. On the contrary, the winding of the laminate in which the resin layer side of the laminate is inwardly placed is hereinafter referred to as “inside winding.”

The speed of winding up of the laminate 10 onto the core 1 is not limited and can be optimized depending on the form of the roll used (including core) and the dimensions of the laminate, and may be determined within the range of from 0.1 m/min to 100 m/min.

Winding may be conducted with a center drive rewind system in which the core 1 may rotate with force. Alternatively, winding may be conducted with a surface drive rewind system, which has a driving roller to wind the laminate 10 on a freely turning core frictionally.

The laminate may be wound with tension into a roll as long as the laminate does not break or shrink too much.

When the laminate is wound, a spacer may be wound together to make a space between the resin layer and the back surface (i.e., surface opposite to surface on which resin layer is prepared) of the metal foil so that the resin layer of the inner portion of the roll does not directly contact the rear surface of the metal foil of the outer portion of the roll. The space may be no less than 200 μm, and is preferably no less than 300 μm, and is more preferably no less than 500 μm.

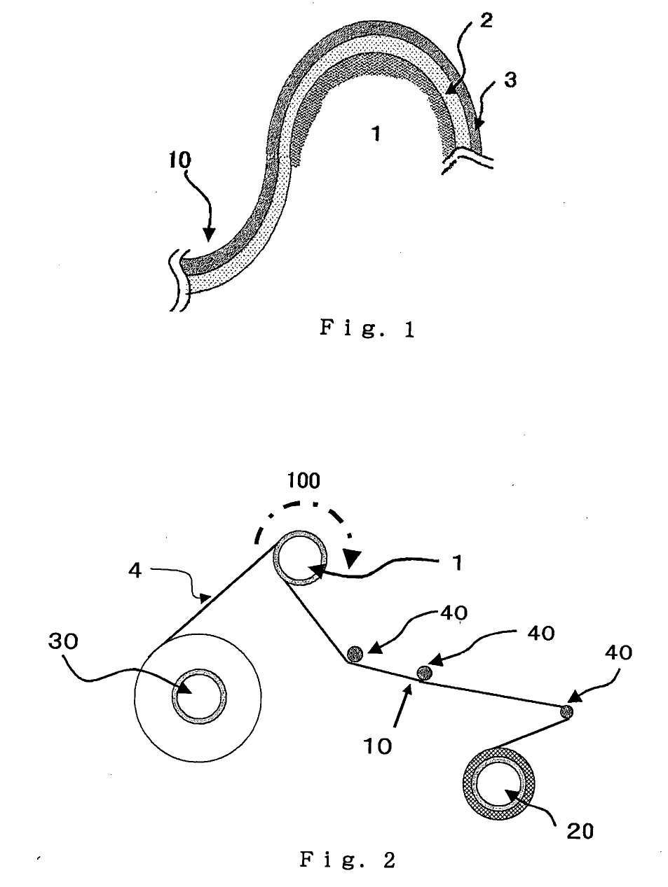

FIG. 2 is a cross sectional diagram schematically illustrating one example process for winding a laminate 10 onto a core 1 together with a spacer. The core 1 is rotated in clockwise direction 100 as seen in the figure. The laminate 10 is fed through guide rolls 40, 40, 40 from a core 20 where the laminate is temporarily placed, and at the same time, a spacer 4 is fed from a core 30 to the core 1 where the spacer is temporarily placed. The spacer and the laminate are gathered together and are wound together around the core 1.

The spacer may be a cloth material which can create a space in the roll-form laminate as described above, may be a material having permeability to the extent that the gas generated (which may be from the laminate) during a heat treatment described below can be efficiently removed, and is preferably a material having heat resistance at a temperature of no lower than 200° C. The spacer may be selected from materials which does not deform due to, for example, shrink, soften or fuse, at the temperature of the heat treatment. Example of the materials for the spacer include meshes and non-woven cloths, both of which may be made from cellulose fibers, glass fibers, carbon fibers, aramid fibers, alumina fibers, polybenzooxazole fibers, metal fibers, and metal filaments; and porous materials having through holes made from a heat resistant material.

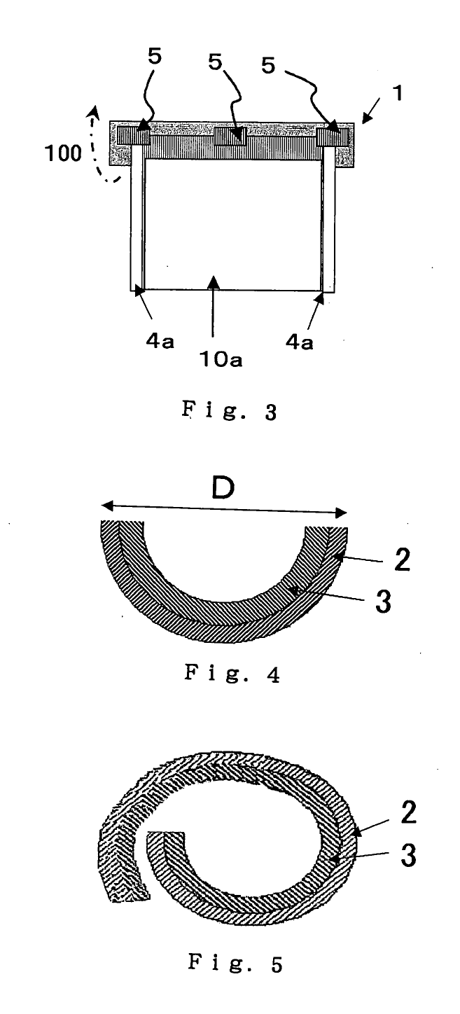

The spacer may be placed on the entire surface of the resin layer, or may be placed only at both edges of the resulting laminate in machine direction. FIG. 3 is a schematic top diagram showing an example laminate as viewed from the resin layer side when wound into a roll with spacers provided on both ends, which is on the verge of the winding. Three pieces of adhesive tapes 5, 5, 5 are used so that an end of the laminate is secured to the core, and the resin layer side faces outside, while spacers 4a, 4a are placed on both edges of the laminate

In the present invention, the resin layer with the metal foil is wound into a roll so that the resin layer side is placed outward (which is outside winding). When the resin layer with the metal foil is wound into a roll so that the resin layer side is placed inward (which is inside winding), the resulting laminate tends to curl. Although the reason for such a tendency is not clear, it is assumed that the inner stress of the resin layer generated during the subsequent heat treatment (mentioned below) balances with the external stress, thereby the layer receives in winding may provide for good effects in reducing the curling.

Material for the core of roll used in winding is not limited as long as the material has heat resistant and chemical resistant enough to stand under the conditions of heat treatment (mentioned below), and has mechanically strong enough to sustain the total weight of laminate and spacer under the conditions of the heat treatment. Examples of the material for the core include iron, copper, aluminium, titanium, nickel and alloys thereof. Preferred examples include aluminum-magnesium alloy such as A5052, A5056, A5083, and stainless such as SUS304, SUS304L, SUS316 and SUS316L.

The outer diameter of the core may be in the range of from 30 mmφ to 500 mmφ; and is preferably in the range of from 40 mmφ to 300 mmφ, more preferably in the range of from 50 mmφ to 200 mmφ, and most preferably in the range of from 60 mmφ to 158 mmφ.

The roll-form laminate after wound, for example, using a roll of which core has an outer diameter in the range of from 60 mmφ to 158 mmφ, preferably has an outer diameter of from 60 mmφ to 500 mmφ, and more preferably has an outer diameter of from 90 mmφ to 400 mmφ.

After winding the resin layer with the metal foil into a roll form, heat treatment may be carried out in a state where the roll is placed around the core as mentioned above. The heat treatment may be conducted as a temperature of from 200° C. to 350° C., while the lower limit of the temperature is preferably 250° C. (which means that the preferable temperature is 250° C. or higher), and the lower limit is more preferably 280° C. On the other hand, the upper limit of the temperature is preferably 340° C. (which means that the preferable temperature is 340° C. or lower), and the upper limit is more preferably 330° C.

The heat treatment may be carried out over a period of time of from 10 minutes to 15 hours. The treatment is preferably conducted for 20 minutes or longer, and is more preferable for 40 minutes or longer. Meanwhile, the treatment is preferably conducted for 12 hours or shorter, and is more preferable for 10 hours or shorter.

It is preferred to carry out the heat treatment in an inert gas such as nitrogen, argon and neon, or to carry out the treatment in a vacuum, in order to prevent the deterioration of the metal foil due to oxidation.

After carrying out the heat treatment, the laminate may be cooled by, for example, standing to cool, removed from the core, separated from the spacer (if used), slit (i.e., cut in longitudinal direction of laminate (MD)) and cut (i.e., cut in vertical direction of laminate (TD)), to provide a laminate comprising an aromatic liquid-crystalline polyester.

If necessary, the surface of the laminate may be polished or treated with a chemical such as an acid and an oxidant. Alternatively, another process as an ultraviolet ray radiating process or a plasma radiating process may be carried out.

Thus obtained laminate having the liquid-crystalline polyester layer are excellent in flexibility and dimensional stability and with less curling. Based on such advantages, the laminate can be appropriately used as base films for copper clad laminate, films for multilayer printed boards used in semiconductor packages or mother boards (in a buildup method), films for flexible printed wiring boards, films for tape automated bonding, films for RFID tag tapes, wrapping films for heating in microwave ovens and films for shielding against electromagnetic waves.

In addition, the laminate in the present invention may be excellent in high frequency characteristics and low water absorption properties, and thus is suitably used for high frequency printed wiring boards, high frequency cables, circuits for telecommunication apparatuses and substrates for packaging.

It is noted that, while the thickness of the laminate is preferably within the above-described range, the thickness may be no less than 10 μm in the case where particularly high insulation is required, for example, at the time when the laminate is utilized in FPC.

The invention being thus described, it will be apparent that the same may be varied in many ways. Such variations are to be regarded as within the spirit and scope of the invention, and all such modifications as would be apparent to one skilled in the art are intended to be within the scope of the following claims.

The entire disclosure of the Japanese Patent Application No. 2006-181144 filed on Jun. 30, 2006, including specification, claims, drawings and summary, are incorporated herein by reference in their entirety.

### EXAMPLES

The present invention is described in more detail by following Examples, which should not be construed as a limitation upon the scope of the present invention.

Curl degree for evaluating laminates obtained below was measured as follows:

From the laminate to be evaluated, a piece of laminate (150 mm×150 mm) was cut off. The cut piece was placed on a flat plate so that the copper foil side of the laminate faces the plate. After that, the distance (unit: mm) between both edges of the copper foil was measured.

In the case when the laminate did not curl so much and distance D was able to be measured (see, FIG. 3), then curl degree was calculated by equation below:

Curl degree=(150−D)/150

In such a case, Curl Degree is in the range of from 0 to 1.

In the case when the laminate curled so much and distance D was not able to be measured (see, FIG. 4), Curl Degree was regarded to be “larger than 1”.

Smaller curl degree means that the laminate is difficult to curl, desirably.

### Synthetic Example 1

2-Hydroxy-6-naphthoic acid (941 g; 5.0 mol), 4-aminophenol (273 g; 2.5 mol), isophthalic acid (415.3 g; 2.5 mol) and acetic acid anhydride (1123 g; 11 mol) were put in a reactor having a stirring apparatus, a torque meter, a gas inlet for introducing nitrogen gas, a thermometer and a reflux condenser. The atmosphere within the reactor was sufficiently replaced with a nitrogen gas, and after that, the temperature was raised to 150° C. over 15 minutes while the nitrogen gas was flowing, and was refluxed for 3 hours while this temperature was maintained.

After that, the temperature was raised to 320° C. over 170 minutes while a distillate acetic acid, which is a byproduct, and acetic acid anhydride, which had not reacted, were removed, and the point in time when an increase in the torque was recognized was considered as the completion of reaction, and the contents were taken out. The obtained solid was cooled to a room temperature (about 20° C.) and roughly crushed in a crusher, and a polymerization reaction was conducted in a solid phase in a nitrogen atmosphere where the temperature was maintained at a temperature of 250° C. for 10 hours to obtain a liquid-crystalline polyester powder.

### Synthetic Example 2

2-Hydroxy-6-naphthoic acid (84.7 g; 0.45 mol), 4-hydroxyacetoanilide (41.6 g; 0.275 mol), isophthalic acid (12.5 g; 0.075 mol), diphenyl ether-4,4′-dicarboxylic acid (51.7 g; 0.20 mol) and acetic acid anhydride (81.7 g; 1.1 mol) were put in a reactor having a stirring apparatus, a torque meter, a gas inlet for introducing nitrogen gas, a thermometer and a reflux condenser. The atmosphere within the reactor was sufficiently replaced with a nitrogen gas, and after that, the temperature was raised to 150° C. over 15 minutes while the nitrogen gas was flowing, and was refluxed for 3 hours while this temperature was maintained.

After that, the temperature was raised to 320° C. over 170 minutes while a distillate acetic acid, which is a byproduct, and acetic acid anhydride, which had not reacted, were removed, and the point in time when an increase in the torque was recognized was considered as the completion of reaction, and the contents were taken out. The obtained solid was cooled to room temperature and roughly crushed in a crusher, and a polymerization reaction was induced in the solid phase in a nitrogen atmosphere where the temperature was maintained at a temperature of 250° C. for 3 hours to obtain a liquid-crystalline polyester powder.

### Example 1

The liquid-crystalline polyester powder (32 g) obtained in Synthetic Example 1 was added to 368 g of N-methyl-2-pyrrolidone, and then, the mixture was heated to 140° C., so that the powder completely dissolved to obtain a transparent brown liquid-crystalline polyester solution composition. Aluminum borate (7.79 g, Alborex M20C (trade name), made by Shikoku Chemicals Corporation) was added to the solution composition as an inorganic filler to obtain a liquid-crystalline polyester solution composition (hereinafter, referred to as “liquid-crystalline polyester solution composition 1”). Next, the solution composition 1 was applied on an electrolytic copper foil (3EC-VLP, having a thickness of 18 μm, made by Mitsui Mining & Smelting Co., Ltd.) using a film applicator, so that the thickness of the resin layer after heat treatment became 15 μm. The resin layer was heated to 120° C. with a high temperature forced convection oven, so that the solvent was removed to be remained in the amount of no larger than 18% by weight. The resin layer on the foil was is then wound onto an SUS316L tube (as a core) having an outer diameter of 89.1 mm with the resin layer side outward (outside winding) together with glass cloth tapes having a width of 35 mm and a thickness of 1.5 mm, which were placed on both edges of the resin layer. The wound roll was put in a high temperature inert gas oven, and heat treatment was carried out at 320° C. for 1 hour in a nitrogen atmosphere to obtain a laminate having liquid-crystalline polyester film without curling. The curl degree of the laminate was measured and is shown in Table 1.

### Comparative Example 1

A laminate having liquid-crystalline polyester film was obtained by the same process as in Example 1, except that the winding was changed from outside winding to inside winding. Curl degree of the laminate was measured and is shown in Table 1.

### Comparative Example 2

A laminate having liquid-crystalline polyester film was obtained by the same process as in Example 1, except that instead of winding, the resin layer with the copper foil was fixed to SUS tray with adhesive tape, followed by a heat treatment at a temperature of 320° C. for 1 hour. Curl degree of the laminate was measured and is shown in Table 1.

TABLE 1

| | Manner of | Outer diameter of | |
|---|---|---|---|
| | winding | the core used(mm) | Curl degree |
| Example 1 | Outside | 89.1 | 0.10 |
| | winding | | |
| Comparative | Inside | 89.1 | Larger than 1 |
| Example 1 | winding | | |
| Comparative | No winding | — | 0.13 |
| Example 2 | | | |

### Example 2 and Comparative Examples 3 and 4

Laminates were obtained by the same processes as in Example 1 and Comparative Examples 1 and 2, respectively, except that the thickness of the resin layer obtained after the heat treatment was 25 μm. Curl degrees of the laminates were measured and are shown in Table 2.

TABLE 2

| | Manner of | Outer diameter of | |
|---|---|---|---|
| | winding | the core used(mm) | Curl degree |
| Example 2 | Outside | 89.1 | 0.15 |
| | winding | | |
| Comparative | Inside | 89.1 | Larger than 1 |
| Example 3 | winding | | |
| Comparative | No winding | — | 0.21 |
| Example 4 | | | |

### Example 3 and Comparative Examples 5 and 6

Laminates were obtained through the same processes as in Example 1 and Comparative Examples 1 and 2, respectively, except that liquid-crystalline polyester solution composition 2 (in which no filler was contained) was used instead of using liquid-crystalline polyester solution composition 1. Curl degrees of the laminates were measured and are shown in Table 3.

TABLE 3

| | Manner of | Outer diameter of | |
|---|---|---|---|
| | winding | the core used(mm) | Curl degree |
| Example 3 | Outside | 89.1 | 0.13 |
| | winding | | |
| Comparative | Inside | 89.1 | Larger than 1 |
| Example 5 | winding | | |
| Comparative | No winding | — | Larger than 1 |
| Example 6 | | | |

### Example 4

The liquid-crystalline polyester powder (80 g) obtained in Synthetic Example 2 was added to 920 g of N-methyl-2-pyrrolidone, and then, the mixture was heated to 160° C., so that the powder completely dissolved, and thus, a transparent brown liquid-crystalline polyester solution composition was obtained. Next, this solution composition was applied onto an electrolytic copper foil (3EC-VLP, having a thickness of 18 μm, made by Mitsui Metal Co., Ltd.) using a film applicator, so that the thickness of the resin layer after heat treatment became 15 μm, and after that, heated to 120° C. with a high temperature forced convection oven, so that the solvent was removed. The resin layer on the foil was then wound onto an SUS316L tube (as a core) having an outer diameter of 89.1 mm with the resin layer side outward (outside winding) together with glass cloth tapes having a width of 35 mm and a thickness of 1.5 mm, which were placed on both edges of the resin layer. The wound roll was put in a high temperature inert gas oven, and heat treatment was carried out at 320° C. for 1 hour in a nitrogen atmosphere to obtain a laminate having liquid-crystalline polyester film without curling. Curl degree of the laminate was measured and is shown in Table 4.

### Comparative Example 7

A laminate having liquid-crystalline polyester film was obtained by the same process as in Example 4, except that the winding was changed from outside winding to inside winding.

Curl degree of the laminate was measured and is shown in Table 4.

### Comparative Example 8

A laminate having liquid-crystalline polyester film was obtained by the same process as in Example 4, except that instead of winding, the resin layer with the copper foil was fixed to SUS tray with adhesive tape, followed by a heat treatment at a temperature of 320° C. for 1 hour. Curl degree of the laminate was measured and is shown in Table 4.

TABLE 4

| | Manner of | Outer diameter | |
|---|---|---|---|
| | winding | of the core (mm) | Curl degree |
| Example 4 | Outside | 89.1 | 0.0067 |
| | winding | | |
| Comparative | Inside | 89.1 | 0.13 |
| Example 7 | winding | | |
| Comparative | No winding | — | 0.041 |
| Example 8 | | | |

### Example 5 and Comparative Examples 9 and 10

Laminates were obtained by the same processes as in Example 4 and Comparative Examples 7 and 8, respectively, except that the thickness of the resin layer obtained after heat treatment was 25 μm. Curl degrees of the laminates were measured and are shown in Table 5.

TABLE 5

| | Manner of | Outer diameter of | |
|---|---|---|---|
| | winding | the core used(mm) | Curl degree |
| Example 5 | Outside | 89.1 | 0.017 |
| | winding | | |
| Comparative | Inside | 89.1 | Larger than 1 |
| Example 9 | winding | | |
| Comparative | No winding | — | 0.079 |
| Example 10 | | | |

### Example 6 and Comparative Example 11

Laminates were obtained through the same processes as in Example 5 and Comparative Example 9, respectively, except that the outer diameter of the core of the roll was 158 mm. Curl degrees of the laminates were measured and are shown in Table 6.

TABLE 6

| | Manner of | Outer diameter of | |
|---|---|---|---|
| | winding | the core used(mm) | Curl degree |
| Example 6 | Outside | 158 | 0.036 |
| | winding | | |
| Comparative | Inside | 158 | 0.17 |
| Example 11 | winding | | |

### Example 7 and Comparative Example 12

Laminates were obtained through the same processes as in Example 5 and Comparative Example 9, except that the outer diameter of the core of the roll was 60 mm. Curl degrees of the laminates were measured and are shown in Table 7.

TABLE 7

| | Manner of | Outer diameter of | |
|---|---|---|---|
| | winding | the core used(mm) | Curl degree |
| Example 7 | Outside | 60 | 0.0067 |
| | winding | | |
| Comparative | Inside | 60 | Higher than 1 |
| Example 12 | winding | | |

What is claimed is:

1. A method for producing a laminate comprising a liquid-crystalline polyester resin layer and a metal foil, the method comprising the steps of:
preparing a resin layer containing a liquid-crystalline polyester on one side of a metal foil;
winding the resin layer with the metal foil into a roll so that the resin layer is outward; and
subjecting the roll to a heat treatment.

2. The method according to claim 1, wherein the winding is conducted using a roll of which core has an outer diameter of from 30 mmφ to 500 mmφ.

3. The method according to claim 1, wherein a spacer is wound together when the resin layer with the metal foil is is wound into the roll.

4. The method according to claim 1, wherein the heat treatment is carried out in a temperature range of from 200° C. to 350° C.

5. The method according to claim 1, wherein the liquid-crystalline polyester is an aromatic liquid-crystalline polyester.

6. The method according to claim 5, wherein the aromatic liquid-crystalline polyester is soluble in a solvent.

7. The method according to claim 5, wherein the resin layer is prepared on the metal foil by applying a solution composition comprising the aromatic liquid-crystalline polyester and a solvent onto the metal foil and removing at least a portion of the solvent in the solution composition.

8. The method according to claim 7, wherein the amount of solvent remaining in the resin layer obtained after the step of removing the solvent is no more than 18% by weight on a basis of the resin layer.

9. The method according to claim 5, wherein the aromatic liquid-crystalline polyester has structural units represented by formulas (i) to (iv) respectively below:
—O—Ar1-CO—, (i)
—X—Ar2-Y—, (ii)
—CO—Ar3-CO— and (iii)
—CO—Ar4-Z-Ar5-CO—, (iv)
wherein Ar1 represents at least one selected from a group consisting of 1,4-phenylene, 2,6-naphthylene and 4,4′-biphenylene; Ar2 represents at least one selected from a group consisting of 1,4-phenylene, 1,3-phenylene and 4,4′-biphenylene; X and Y independently represent —O— or —NH—; Ar3 represents at least one selected from a group consisting of 1,4-phenylene, 1,3-phenylene and 2,6-naphthylene; Ar4 and Ar5 independently represent at least one selected from a group consisting of 1,4-phenylene, 2,6-naphthylene and 4,4′-biphenylene; and Z represents at least one selected from a group consisting of —O—, —SO₂— and —CO—, in which the amount of unit (1) is 30-80% by mol, the amount of unit (2) is 10-35% by mol and the total amount of units (3) and (4) is 10-35% by mol, the amounts of which are all on the molar basis of the total amount of monomers (1) to (4).

10. A laminate comprising a liquid-crystalline polyester resin layer and a metal foil, obtained by the method according to claim 1.

11. A flexible printed wiring board comprising the laminate according to claim 10.
